(19) United States
(12) Patent Application Publication
(10) Pub. No.: US 2025/0303435 A1
(43) Pub. Date: Oct. 2, 2025

(54) Fluid Treatment Application Device

(71) Applicant: Larry Vealetzek, Winsted, MN (US)

(72) Inventor: Larry Vealetzek, Winsted, MN (US)

(21) Appl. No.: 18/620,861

(22) Filed: Mar. 28, 2024

(51) Int. Cl. B05C 17/10

(52) U.S. Cl. CPC B05C 17/10

(57) ABSTRACT

A fluid treatment application device for applying fluid treatments such as wood stain to surfaces such as wood includes a base plank having a top side, a bottom side, and a peripheral surface. A pad is coupled to the base plank and covers the top side, the bottom side and the peripheral surface. The pad is an absorbent material that absorbs a fluid treatment. A cloth is coupled to the pad. The pad is positioned between the base plank and the cloth. The cloth is a synthetic wool material wherein the cloth releases the fluid treatment onto a surface when a user moves the base plank across an external surface. The cloth is fluffy to facilitate the user in treating tiered levels and molding. A handle coupled to the base plank extends upwardly through the pad and the cloth.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to applicators and more particularly pertains to a new applicator for applying fluid treatments such as wood stain or varnish to surfaces such as wood.

### (2) Description of Related Art Including Information Disclosed Under 37 CFR 1.97 and 1.98

The prior art relates to applicators. Various tools and devices are disclosed for applying fluid treatments such as stain, paint, or varnish to surfaces such as wood. For example, a piece of wooden furniture, such as a cabinet, may be finished by applying a stain treatment to the wood. A craftsperson may use a brush, roller, or sponge to transfer the fluid treatment onto the surface. However, the construction of such tools can make them difficult to maneuver in every direction. Thus, there is a need for a device that is easily moved across the surface in any direction so that the user can apply an even coat of the fluid treatment across the entirety of the surface. The size of such tools can inhibit the craftsperson from dipping the tool into a can or other container of the fluid treatment. Thus, the ideal device would be small enough to easily fit into the container of the fluid treatment. Finally, the prior art devices are difficult to use when finishing complexly shaped surfaces, such as crown molding, lips, or sharp corners, often requiring the craftsperson to use multiple devices to finish a single project. Thus, the ideal device would also be flexible enough to fit into the crevices and small corners of the surface so that a single device can be used to finish the entire project.

### BRIEF SUMMARY OF THE INVENTION

An embodiment of the disclosure meets the needs presented above by generally comprising a base plank having a top side, a bottom side, and a peripheral surface that is coupled to and extends between the top side and the bottom side. A pad is coupled to the base plank. The pad extends around the base plank wherein the pad covers the top side, the bottom side and the peripheral surface. The pad comprises an absorbent material that is configured to absorb a fluid treatment. A cloth is coupled to the pad wherein the pad is positioned between the base plank and the cloth. The cloth comprises a synthetic wool material wherein the cloth is configured to release the fluid treatment onto an external surface when a user moves the base plank across the external surface. The cloth is configured to facilitate the user in treating the external surface with the fluid treatment. The cloth is fluffy wherein the cloth is configured to facilitate the user in treating tiered levels and molding on the external surface. A handle is coupled to the base plank. The handle extends upwardly from the top side of the base plank, through the pad and the cloth.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a fluid treatment application device according to an embodiment of the disclosure.

FIG. 2 is a top view of an embodiment of the disclosure.

FIG. 3 is a side view of an embodiment of the disclosure.

FIG. 4 is a cross-sectional view of an embodiment of the disclosure.

FIG. 5 is an in-use view of an embodiment of the disclosure.

### DETAILED DESCRIPTION OF THE INVENTION

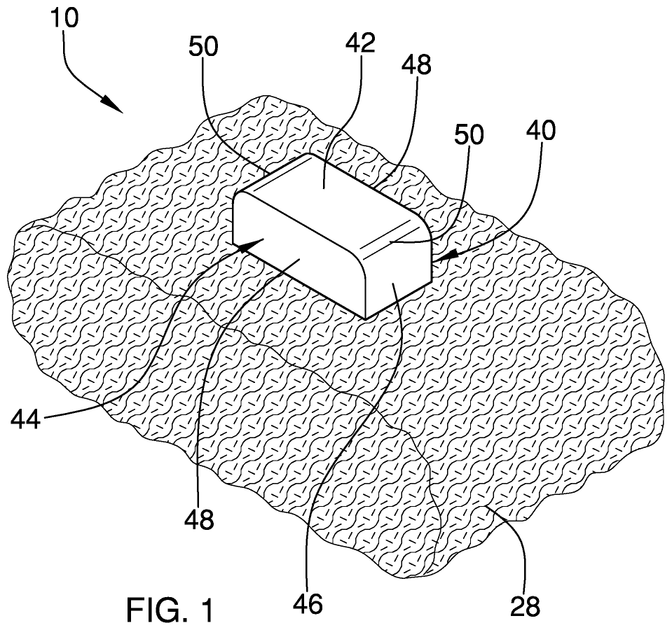

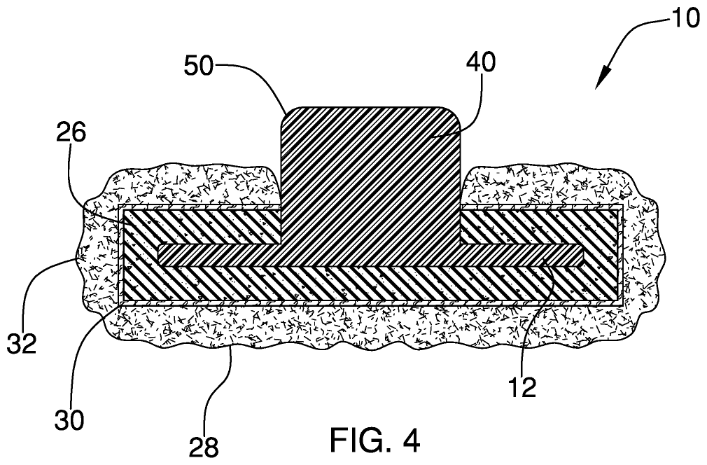

With reference now to the drawings, and in particular to FIGS. 1 through 5 thereof, a new applicator embodying the principles and concepts of an embodiment of the disclosure and generally designated by the reference numeral 10 will be described.

As best illustrated in FIGS. 1 through 5, the fluid treatment application device 10 generally comprises a base plank 12 that has a top side 14, a bottom side 16, and a peripheral surface 18 that is coupled to and extends between the top side 14 and the bottom side 16. The bottom side 16 may be planar. The base plank 12 may comprise one of a wood material and a plastic material.

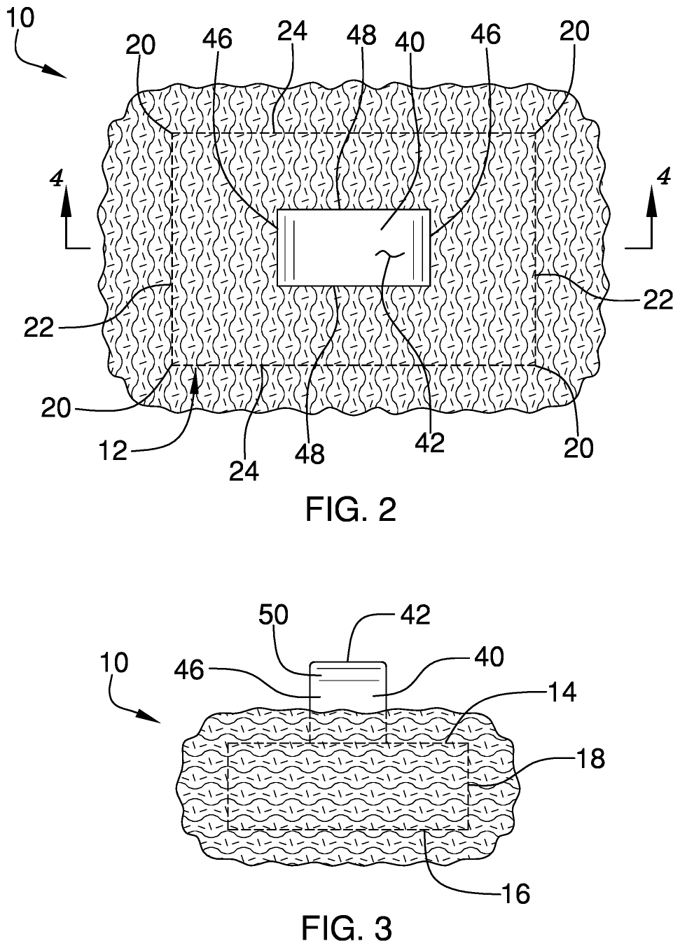

The base plank 12 is generally rectangular wherein the base plank 12 has four corners 20, each corner of the four corners 20 may be squared, as shown in FIGS. 2-4. The base plank 12 may have a length between 2.5 inches and 3.5 inches. The base plank 12 may have a width between 3.5 inches and 5.5 inches. The base plank 12 may have a height between 0.125 inches and 0.5 inches. The base plank 12 may further comprise a first pair of ends 22 and a second pair of ends 24 extending between the first pair of ends 22. Each of the second pair of ends 24 may have a length exceeding a length of the first pair of ends 22.

A pad 26 is coupled to the base plank 12. The pad 26 generally extends around the base plank 12 wherein the pad 26 covers the top side 14, the bottom side 16 and the peripheral surface 18 of the base plank 12. The pad 26 generally comprises an absorbent material that is configured to absorb a fluid treatment such as a wood stain or a varnish. For example, the absorbent material may comprise a foam material such as a polyurethane sponge material. The pad 26 may have a thickness between 0.25 inches and 0.75 inches.

A cloth 28 is coupled to the pad 26 wherein the pad 26 is positioned between the base plank 12 and the cloth 28 wherein the cloth 28 is configured to release the fluid treatment onto an external surface 34 when a user 54 moves the base plank 12 across the external surface 34. The cloth 28 is thus configured to facilitate the user 54 in treating the external surface 34 with the fluid treatment. The cloth 28 is generally coextensive with the pad 26. The cloth 28 is generally fully separated from the base plank 12 by the pad 26. The cloth 28 may comprise a synthetic wool material. For example, the synthetic wool material may comprise a pile fabric such as a SHERPA material.

The synthetic wool material of the cloth 28 generally includes an inner surface 30 that is positioned adjacent to the pad 26. The inner surface 30 is generally smooth wherein the inner surface 30 is configured to abut the pad 26. The cloth 28 absorbs the fluid treatment, which can absorb evenly across the pad 26 because the inner surface 30 is smooth and lays evenly across the pad 26.

The synthetic wool material of the cloth 28 also generally includes an outer surface 32. The outer surface 32 is generally fluffy wherein the outer surface 32 is configured to facilitate the user 54 in treating tiered levels 36 and molding 38 on the external surface 34. The outer surface 32 is generally fluffy wherein the outer surface 32 is configured to facilitate the cloth 28 in absorbing the fluid treatment. The outer surface 32 may also comprise relatively short threads of the synthetic wool material to facilitate even application of the fluid treatment to the external surface 34, and to inhibit the fluid treatment from streaking as the fluid treatment is pulled across the external surface 34.

A handle 40 is coupled to the base plank 12. The handle 40 extends upwardly from the top side 14 of the base plank 12. The handle 40 may extend through the pad 26 and the cloth 28 wherein the pad 26 and the cloth 28 abut the handle 40 over the top side 14 of the base plank 12. The handle 40 may be centrally positioned on the top side 14 of the base plank 12. The handle 40 may have a cuboid shape. For example, the handle 40 may have a length between 1.0 inch and 2.0 inches, a width between 1.5 inches and 2.5 inches, and a height between 0.5 inches and 1.0 inch.

The handle 40 may further include an upper surface 42 that is distal to the base plank 12. The upper surface 42 may be elongated. A plurality of side surfaces 46 is coupled to and extends downwardly from the upper surface 42 to the top side 14 of the base plank 12. In embodiments where the handle 40 has the cuboid shape, the plurality of side surfaces 46 generally includes four side surfaces.

For example, the plurality of side surfaces 46 may include a first pair of side surfaces 46 that is aligned with the first pair of ends 22 of the base plank 12. A second pair of side surfaces 48 may extend between the first pair of side surfaces 46. The second pair of side surfaces 48 may be aligned with the second pair of ends 24 of the base plank 12. Each of the second pair of side surfaces 48 may have a length exceeding a length of the first pair of side surfaces 46.

The handle 40 may further include a pair of curved edges 50 extending between the upper surface 42 and the first pair of side surfaces 46. In other words, each curved edge of the pair of curved edges 50 may be positioned between the upper surface 42 and a respective side surface of the first pair of side surfaces 46. Each curved edge of the pair of curved edges 50 may be convexly arcuate between the upper surface 42 and the respective side surface of the first pair of side surfaces 46.

The four corners 20 of the base plank 12 may be squared wherein the four corners 20 are configured to facilitate the user 54 in treating right angles 52 of the external surface 34. In other words, because each of the four corners 20 is squared, each of the four corners 20 fits snuggly into the right angles 52 and can be positioned flush against the perpendicular sides of the right angles 52 to apply the fluid treatment to the junction between the perpendicular sides.

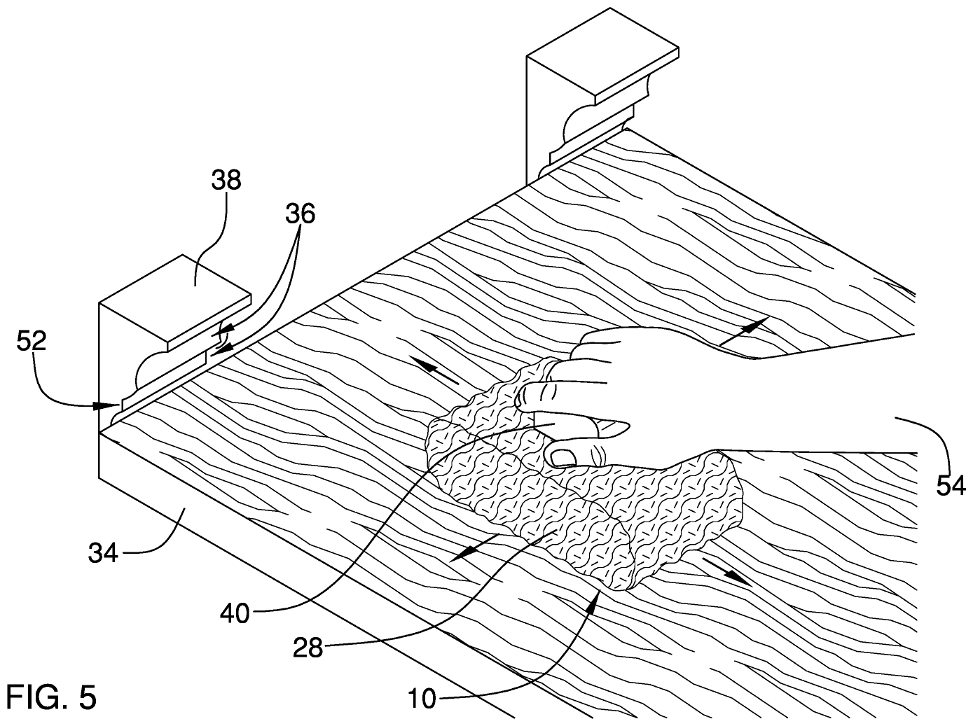

In use, the fluffy outer surface 32 of the cloth 28 is flexible enough to enable the user 54 to apply the fluid treatment to the lips, crevices, and small corners of crown molding 38 or other features on the external surface 34. The handle 40 is easy for the user 54 to grip in any direction, so that the user 54 can easily turn the wood stain application device 10 and so that the user 54 can easily move the wood stain application device 10 in any direction, as indicated in FIG. 5. The size of the base plank 12 facilitates the user 54 in easily dipping the wood stain application device 10 into a container of the fluid treatment. The pad 26 and the fluffy outer surface 32 of the cloth 28 absorb the fluid treatment, enabling the user to cover a greater surface area of the external surface 34 before needing more of the fluid treatment. All edges of the base plank 12 are covered by the pad 26 and the cloth 28 to inhibit the base plank 12 from scratching or damaging the external surface 34 while the fluid treatment is being applied.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wood stain applicator assembly comprising:
a base plank having a top side, a bottom side, and a peripheral surface being coupled to and extending between the top side and the bottom side;
a pad being coupled to the base plank, the pad extending around the base plank wherein the pad covers the top side, the bottom side and the peripheral surface, the pad comprising an absorbent material being configured to absorb a fluid treatment;
a cloth being coupled to the pad wherein the pad is positioned between the base plank and the cloth, the cloth comprising a synthetic wool material wherein the cloth is configured to release the fluid treatment onto an external surface when a user moves the base plank across the external surface and wherein the cloth is configured to facilitate the user in treating the external surface with the fluid treatment, the cloth being fluffy wherein the cloth is configured to facilitate the user in treating tiered levels and molding on the external surface;
a handle being coupled to the base plank, the handle extending upwardly from the top side of the base plank, the handle extending through the pad and the cloth.

2. The wood stain applicator assembly of claim 1, wherein the base plank is rectangular wherein the base plank has four corners, each corner of the four corners being squared wherein the four corners are configured to facilitate the user in treating right angles of the external surface.

3. The wood stain applicator assembly of claim 1, wherein the base plank has a length between 2.5 inches and 3.5 inches.

4. The wood stain applicator assembly of claim 1, wherein the base plank has a width between 3.5 inches and 5.5 inches.

5. The wood stain applicator assembly of claim 1, wherein the base plank has a height between 0.125 inches and 0.5 inches.

6. The wood stain applicator assembly of claim 1, wherein the absorbent material of the pad comprises a foam material.

7. The wood stain applicator assembly of claim 1, wherein the cloth is coextensive with the pad.

8. The wood stain applicator assembly of claim 1, wherein the cloth is fully separated from the base plank by the pad.

9. The wood stain applicator assembly of claim 1, the synthetic wool material of the cloth further comprising an inner surface being positioned adjacent to the pad and an outer surface being fluffy wherein the outer surface is configured to facilitate the user in treating the tiered levels and the molding on the external surface.

10. The wood stain applicator assembly of claim 1, wherein the pad and the cloth abut the handle over the top side of the base plank.

11. The wood stain applicator assembly of claim 1, the handle further comprising an upper surface being distal to the base plank and a plurality of side surfaces being coupled to and extending downwardly from the upper surface to the top side of the base plank.

12. The wood stain applicator assembly of claim 11, the base plank further comprising a first pair of ends and a second pair of ends extending between the first pair of ends.

13. The wood stain applicator assembly of claim 12, wherein each of the second pair of ends of the base plank has a length exceeding a length of the first pair of ends of the base plank.

14. The wood stain applicator assembly of claim 12, the plurality of side surfaces of the handle further comprising:
a first pair of side surfaces being aligned with the first pair of ends of the base plank; and
a second pair of side surfaces extending between the first pair of side surfaces, the second pair of side surfaces being aligned with the second pair of ends of the base plank.

15. The wood stain applicator assembly of claim 14, wherein each of the second pair of side surfaces of the handle has a length exceeding a length of the first pair of side surfaces of the handle.

16. The wood stain applicator assembly of claim 14, the handle further comprising a pair of curved edges extending between the upper surface and the first pair of side surfaces.

17. The wood stain applicator assembly of claim 16, wherein each curved edge of the pair of curved edges is convexly arcuate between the upper surface and a respective one of the first pair of side surfaces.

18. A wood stain applicator assembly comprising:
a base plank having a top side, a bottom side, and a peripheral surface being coupled to and extending between the top side and the bottom side, the bottom side being planar, the base plank being rectangular wherein the base plank has four corners, the base plank having a length between 2.5 inches and 3.5 inches, the base plank having a width between 3.5 inches and 5.5 inches, the base plank having a height between 0.125 inches and 0.5 inches, the base plank comprising one of a wood material and a plastic material, the base plank further comprising:
a first pair of ends;
a second pair of ends extending between the first pair of ends, each of the second pair of ends having a length exceeding a length of the first pair of ends;
a pad being coupled to the base plank, the pad extending around the base plank wherein the pad covers the top side, the bottom side and the peripheral surface of the base plank, the pad comprising an absorbent material being configured to absorb a fluid treatment, the absorbent material comprising a foam material;
a cloth being coupled to the pad, the pad is positioned between the base plank and the cloth wherein the cloth is configured to release the fluid treatment onto an external surface when a user moves the base plank across the external surface and wherein the cloth is configured to facilitate the user in treating the external surface with the fluid treatment, the cloth being coextensive with the pad, the cloth being fully separated from the base plank by the pad, the cloth comprising a synthetic wool material including:
an inner surface being positioned adjacent to the pad;
an outer surface being fluffy wherein the outer surface is configured to facilitate the user in treating tiered levels and molding on the external surface;
a handle being coupled to the base plank, the handle extending upwardly from the top side of the base plank, the handle extending through the pad and the cloth wherein the pad and the cloth abut the handle over the top side of the base plank, the handle being centrally positioned on the top side of the base plank, the handle having a cuboid shape, the handle including:
an upper surface being distal to the base plank, the upper surface being elongated;
a plurality of side surfaces being coupled to and extending downwardly from the upper surface to the top side of the base plank, the plurality of side surfaces including:
a first pair of side surfaces being aligned with the first pair of ends of the base plank;
a second pair of side surfaces extending between the first pair of side surfaces, the second pair of side surfaces being aligned with the second pair of ends of the base plank wherein each of the second pair of side surfaces has a length exceeding a length of the first pair of side surfaces;
a pair of curved edges extending between the upper surface and the first pair of side surfaces, each curved edge of the pair of curved edges being convexly arcuate between the upper surface and a respective one of the first pair of side surfaces; and
the four corners of the base plank being squared wherein the four corners are configured to facilitate the user in treating right angles of the external surface.
